(19) United States
(12) Patent Application Publication
(10) Pub. No.: US 2003/0005429 A1
(43) Pub. Date: Jan. 2, 2003

(54) EPG with video previews

(76) Inventor: Nicholas Colsey, Del Mar, CA (US)

Correspondence Address: MILLER PATENT SERVICES, 2500 DOCKERY LANE, RALEIGH, NC, 27606, US

(21) Appl. No.: 09/894,387

(22) Filed: Jun. 28, 2001

(51) Int. Cl. H04N 7/173; G06F 3/00; H04N 7/16; H04N 5/445; G06F 13/00

(52) U.S. Cl. 725/8; 725/39; 725/91; 725/98; 725/117; 725/118; 725/42; 725/51

(57) ABSTRACT

A method an apparatus for providing a video preview as part of an electronic program guide in a Set-Top Box or other television receiver device. A listing of television programs is presented to a viewer, for example, in the form of a grid showing television programming as a function of time. When a command is transmitted by the viewer from a remote commander to initiate a preview of a specified program, the program is mapped to a video file containing a preview of the specified program. The video file may be stored in a local disc drive or at a service provider head end. The video file can then be played in a window of the electronic program guide to provide a preview of the specified program to the user.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### FIELD OF THE INVENTION

This invention relates generally to the field of electronic program guides (EPG). More particularly, this invention relates to an electronic program guide that permits the user to access video information relating to a program selection.

### BACKGROUND OF THE INVENTION

Cable and satellite television (TV) systems often provide a channel that is used for displaying an electronic programming guide (EPG). The EPG provides a listing of the programs that are available on the cable or satellite system. Typically, the listing includes a plurality of time slots arranged in a column, wherein each time slot has associated with it a row of program information to thus form a grid pattern. The program information may include, for example, the name of the program, the cable channel on which the program may be found, names of actors, whether the program is broadcast in stereo, whether closed captioning is available and other associated information.

The data carrying capacity, or bandwidth, of cable systems continues to rapidly increase. This enables much more information to be transmitted, from more sources, over that which was possible just a short time ago. As such, it is desirable that EPGs be provided that are capable of displaying additional information in a manner that facilitates human interaction with TVs and cable systems.

### SUMMARY OF THE INVENTION

The present invention relates generally to electronic program guides. Objects, advantages and features of the invention will become apparent to those skilled in the art upon consideration of the following detailed description of the invention.

In one embodiment of the present invention a method and apparatus for providing a video preview as part of an electronic program guide in a Set-Top Box or other television receiver device is provided. A listing of television programs is presented to a viewer, for example, in the form of a grid showing television programming as a function of time. When a command is transmitted by the viewer from a remote commander to initiate a preview of a specified program, the program is mapped to a video file containing a preview of the specified program. The video file may be stored in a local disc drive or at a service provider head end. The video file can then be played in a window of the electronic program guide to provide a preview of the specified program to the user.

A method of providing an electronic programming guide, consistent with an embodiment of the present invention includes presenting a listing of television programs to a viewer; receiving a command from the viewer for initiating a preview of a specified program; mapping the specified program to a video file containing a preview of the specified program; and playing the video file to provide a preview of the specified program to the user.

A television Set-Top Box, or other television receiver device, consistent with an embodiment of the present invention has a programmed processor having access to a plurality of video files. An electronic program guide is provided to a display for display to a user. A receiver receives a command from the viewer for initiating a preview of a specified program. A computer program running on the programmed processor that maps the command to one of the plurality of files stored on the video device and plays the video file to the display to provide a preview of the specified program to the user.

An electronic storage medium, consistent with an embodiment of the present invention, stores instructions which, when executed on a programmed processor, carry out a method of providing an electronic programming guide including presenting a listing of television programs to a viewer; receiving a command from the viewer for initiating a preview of a specified program; mapping the specified program to a video file containing a preview of the specified program; and playing the video file to provide a preview of the specified program to the user.

A method of providing program previews to a viewer, consistent with an embodiment of the present invention includes receiving a program preview file from a server; storing the program preview file in a storage device; receiving a program guide from the server; determining from the program guide that the program preview file does not correspond to a program to be available at a future time; and deleting the program preview file from the storage device.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a system block diagram of a system using a set-top box.

FIG. 2 is a functional block diagram of a digital set-top box suitable for use with the present invention.

FIG. 3 is a screen illustrating an exemplary electronic program guide consistent with an embodiment of the present invention.

FIG. 4 is a flow chart illustrating a process consistent with an embodiment of the present invention.

FIG. 5 is a flow chart illustrating a variation of the process of FIG. 4 consistent with an embodiment of the present invention.

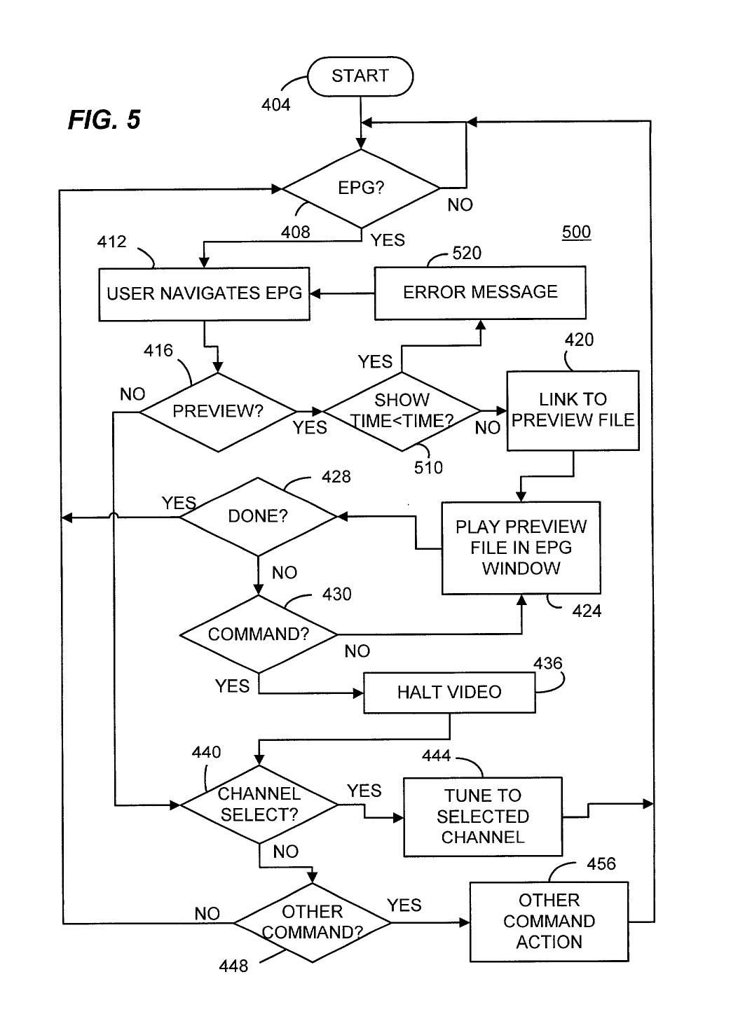

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings. The term “preview” as used herein is intended to embrace any type of moving video information relating to a particular program selection including, without limitation, an MPEG video segment of a movie trailer or television program preview.

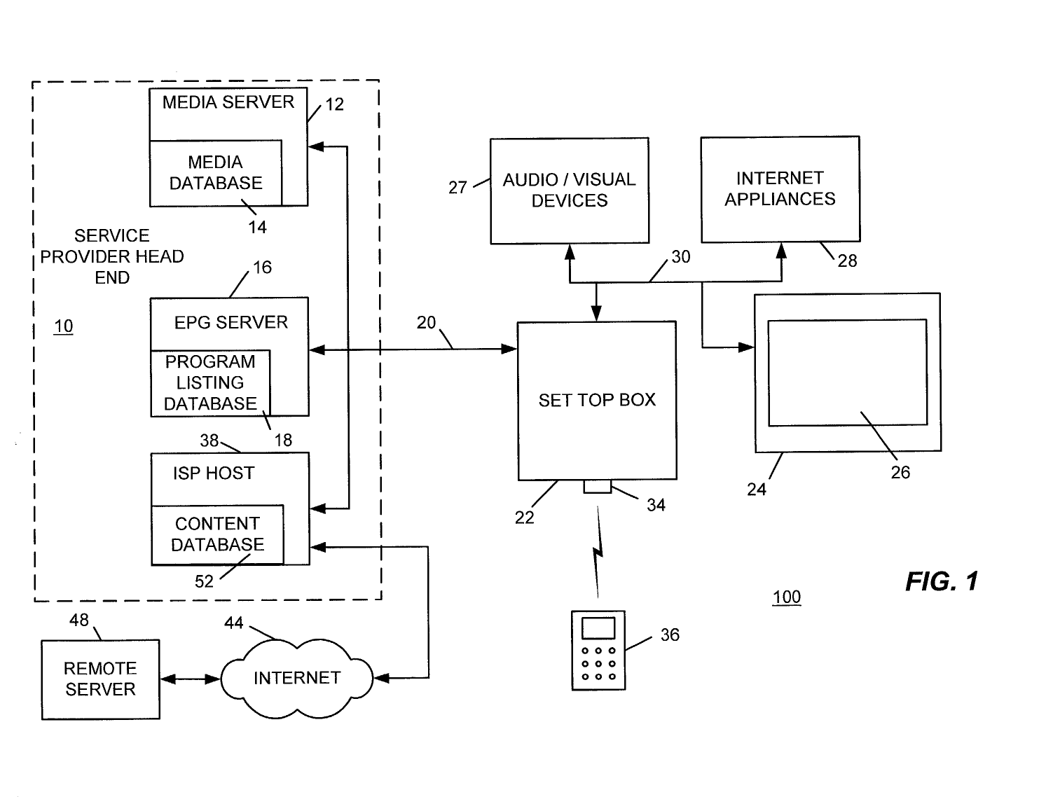

Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-Top Box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet.

The media server 12 and EPG server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, an EPG, etc. The STB 22 may be coupled to the TV 24 and various other audio/visual devices 26 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface Digital Display Working Group, www.ddwg.org) or other suitable interface.

The STB 22 may include a Central Processing Unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Moving Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

In accordance with embodiments of the present invention, the program listing database 18 of EPG server 16 includes not only conventional program listing data that can be presented to the viewer as a grid showing programs by channel and time, but also includes information that links certain of the programs (perhaps all) to video files containing previews of the program. These previews are routinely generated for use as commercials or, in the case of movies, advertisement trailer shown at other theater presentations of the movie. The previews can also be stored in the program listing database or otherwise in the EPG server 16. In certain embodiments, these previews are delivered by streaming video to the STB 22, while in other embodiments, the previews are delivered as file downloads for storage at the STB 22 or a storage device accessible by the STB 22.

While the arrangement illustrated in FIG. 1 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 1 may actually reside in other locations, but from the perspective of the user of STB 22, the service provider 10 serves as a portal to the services shown. Those skilled in the art will appreciate that the illustration of FIG. 1 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Those details can be found in the publicly available CableLabs OpenCable™ specification or in the text “OpenCable Architecture (Fundamentals)” by Michael Adams, Cisco Press, November 1999.

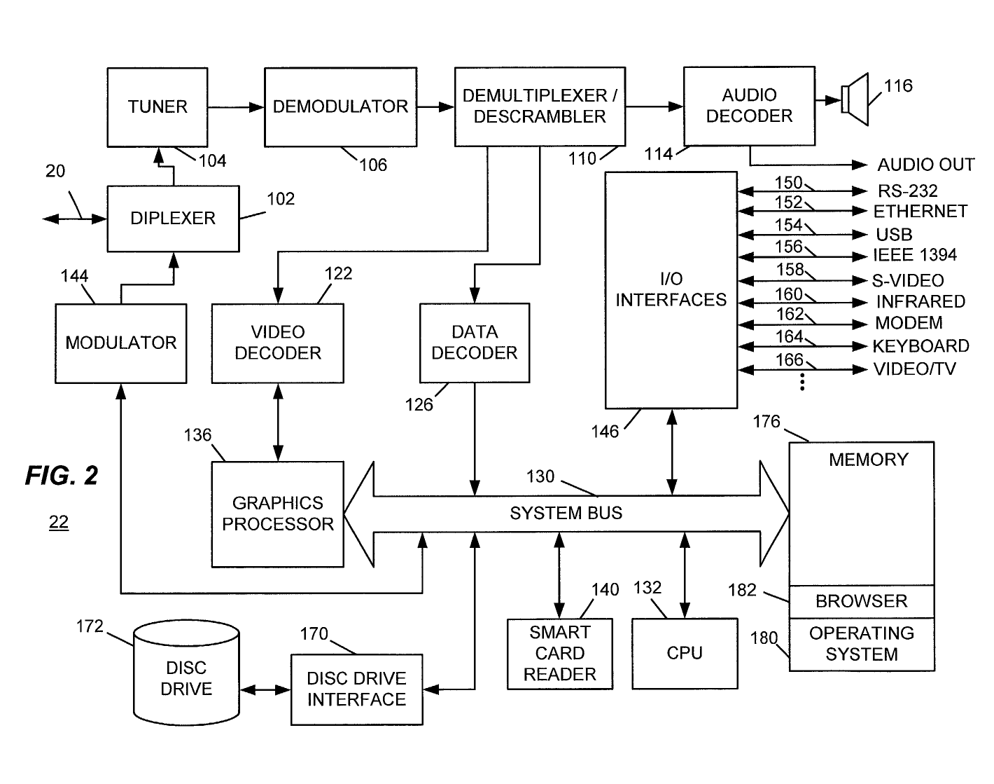

Referring now to FIG. 2, a typical system configuration for a digital Set-Top Box 22 is illustrated. In this exemplary Set-Top Box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A Central Processing Unit (CPU) 132 can thus access the decoded data from data decoder 126 via the system bus 130 (or a separate video bus). Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) Set-Top Box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many Set-Top Boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-Top Box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-link™) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium embodied as a coaxial cable. Thus, the STB 22 can carry out bidirectional communication via the DOCSIS cable modem with the STB 22 being identified by a unique IP address. The DOCSIS specification is publically available.

A PS/2 or other keyboard mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD R/W drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital Set-Top Box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system 180 such as, for example, Sony Corporation's Aperios™ real time operating system is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 22 usually operates using browser software 182 in active memory or may permanently reside in ROM, EEPROM or Flash memory, for example. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside (e.g., browsing, email, EPG, Video On Demand (VOD), rich multimedia applications, pay per view, etc.). The current invention can be utilized with any suitable set-top box software and hardware architecture.

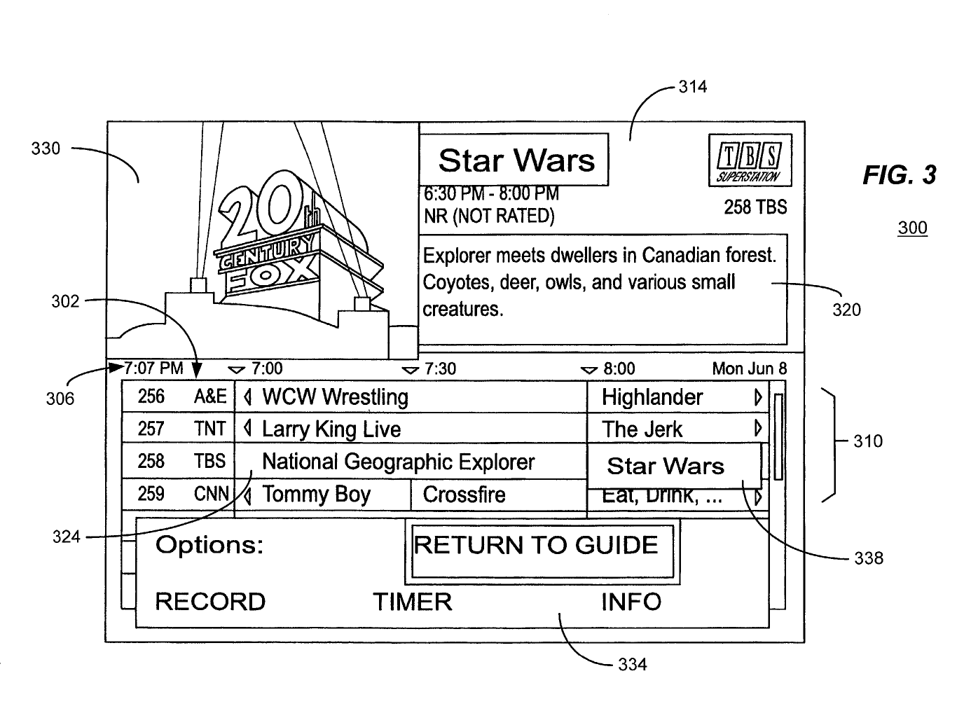

Referring now to FIG. 3, an exemplary EPG screen 300 is illustrated showing one implementation of the present electronic program guide. In this exemplary guide, television channels are displayed in a grid arrangement with a column 302 to the left listing the available channel number and an identifier for the network or channel associated with the various rows. A time line 306 is shown at the top of the grid. The remainder of the grid, shown as 310, presents the programming available in the particular time slots and channels shown.

EPG screen 300 also has a region 314 that identifies the currently selected program as well as a region 320 that provides descriptive information about the currently playing program selection. The currently selected program 324 may be shown in reverse video, a distinct color, bolding, outlining or using some other visual clue to readily identify the currently selected program. Exemplary EPG screen 300 also has a video window 330 that can be used to display a still image associated with the currently selected program, an advertisement or other still image. Trademarks shown (e.g., 20^{th} Century Fox, TBS, TNT, A&E, CNN, etc.) in FIG. 3 are the property of their respective owners, and are used for exemplary purposes only.

In accordance with an embodiment of the present invention, a viewer may wish to find out more information about a future program. For example, the user may wish to find out more about program 338. In some systems, selecting program 338 using commands from remote commander 36 cause information about the program (stored as system information from an MPEG transport stream) is displayed as 320. In accordance with the present invention, selection of the program 338 from the program grid using a specified “preview” command issued from the remote commander 36 causes the CPU 32 of STB 22 to retrieve a video file (e.g., an MPEG video file) and play the moving video file in video window 330. For example, the video file may be a movie trailer or a television commercial spot advertising the particular program. In some embodiments, the video file may also contain advertising content for products, services or programming, providing an additional source of advertising revenue for the content provider or producer.

In one embodiment of the present invention, the video file is stored locally within disc drive 172. The preview file content of this disc drive. Many such preview files can be stored on disc drive 172 without sacrifice of large amounts of storage. For example, 35 movie previews lasting 30 seconds each can be stored in approximately 15 MB of storage assuming each 30 second preview is played at 114 Kbps (e.g., using MPEG 1 video and Audio Layer2). Additional storage (e.g., 750 KB) may be needed for an MPEG 1 player and an audio player implemented in software, but hardware alternatives can also be used.

In accordance with an embodiment of the invention, upon selecting a program and receiving a preview command, the CPU 132 generates a menu window 344 of options that the user can select after initiating a preview. These options can include any number of functions with four exemplary options illustrated. The “Return to Guide” option halts the preview and returns the viewer to the previous state of the EPG. The “Record” option activates a personal video recorder (PVR) or PVR function of the STB 22 (or activates a video tape recorder or PVR) to record the program being previewed. The “Timer” option instructs the STB 22 to select this program for viewing when it starts. The “Info” option takes the user to a screen having additional information about the selection (e.g., reviews, notes about the program, actors, etc.). Those skilled in the art will appreciate that many other options (or fewer options) may be implemented without departing from the invention.

In one embodiment of the invention, the program selected for preview can only be previewed if it is scheduled for a time in the future or the present. Previews of programs that have already been presented can thus be removed from the disc drive 172 of the STB 22 to preserve storage space. The previews are thus downloaded from the EPG server 16 via cable modem or other communication media and stored in the disc drive 172 until no longer potentially needed. Thus, the program preview files are provided to the STB 22 by EPG server 16 and stored on the disc drive 172. The EPG is also sent from the server 16 and stored on the disc drive 172 or other storage mechanism. Once the last presentation of a particular program has been made, the CPU 132 determines from the program guide that the program preview file does not correspond to a program to be available at a future time and deletes the program preview file from the disc drive 172. The available previews are preferably mapped to the program in a table stored within the disc drive 172. Whenever a new preview is received, the table is updated to reflect the availability of a new preview. Similarly, whenever a preview is no longer needed, it is deleted from the table.

In another embodiment of the invention, the program previewfiles are stored at the service provider head end 10 within EPG server 16. Whenever a viewer issues a preview command, the EPG server 16 is contacted by the STB 22 with a request to send the preview file. The EPG server 16 can then either download the file to the STB 22's disc drive 172, or can stream the video file to the STB 22 for playback.

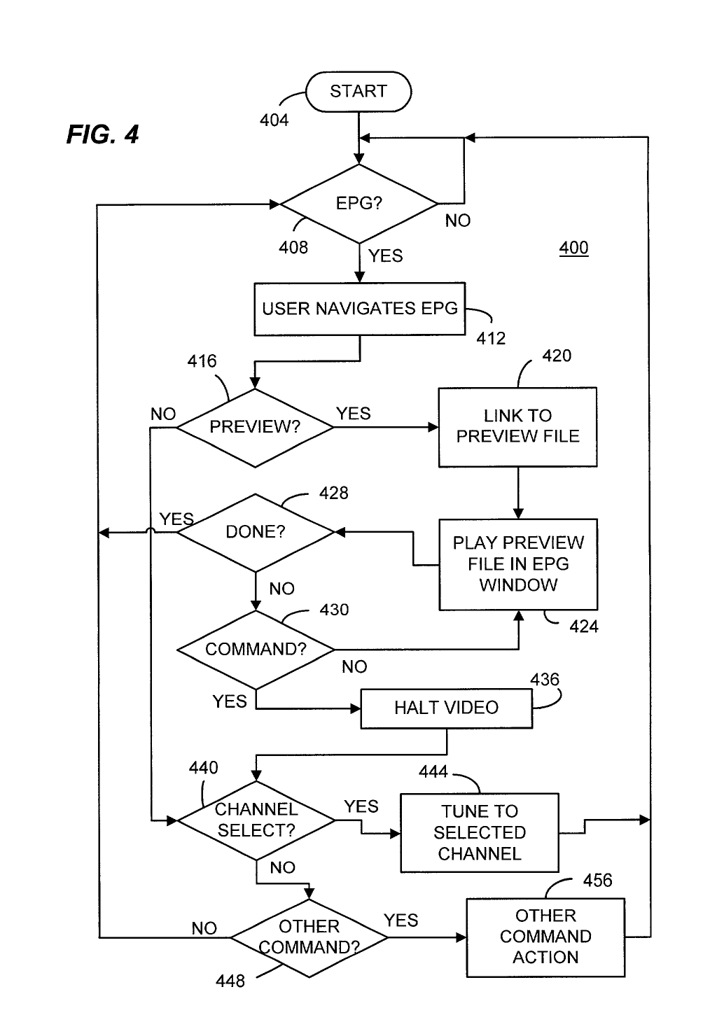

An overview of the process just described is illustrated as process 400 of FIG. 4 starting at 404. When the user activates the EPG by issuing a command from the remote commander 36 at 408, the system is placed in an EPG navigation mode at 412. If the user elects to preview a selection at 416, the STB 22 links to the appropriate preview file at 420 associated with the program selected by the user (as determined by a stored table mapping the preview file to the program). The preview file is then played in the video window 330 within the EPG at 424. When the preview is done at 428, control returns to 408 to await the next activation of the EPG. If in the meantime, at 430, the user issues a command, the video is halted at 436 so that the user command can be acted upon. If the command is a channel selection at 440, the tuner 104 within the Set-Top Box 22 is directed to tune to a specified channel at 444 and control returns to 408. If the command is not a channel selection at 440, but is another command at 448, the other command is acted on at 456 and control returns to 408.

FIG. 6 illustrates a variation of this process shown as process 500. In process 500, when the user elects to preview a program at 416, the Set-Top Box 22 determines if the selected program time is prior to the current time at 510. If so, an error message is issued at 520 and control returns to 412. In this embodiment, the user is only permitted to view a preview of a program that will be appearing in the future.

While the present invention has been described in terms of a television Set-Top Box, the relevant workings of the STB 22 can be incorporated within the housing of a television set or other television receiver device without departing from the present invention.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, multi-processor systems, dedicated processors and/or dedicated hard wired logic may be used to construct alternative equivalent embodiments of the present invention.

Those skilled in the art will appreciate that the program steps and associated data used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form that can be stored on any suitable electronic storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, additional operations can be added, or operations can be omitted without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of providing an electronic programming guide, comprising:
presenting a listing of television programs to a viewer;
receiving a command from the viewer for initiating a preview of a specified program;
mapping the specified program to a video file containing a preview of the specified program; and
playing the video file to provide a preview of the specified program to the user.

2. The method according to claim 1, wherein the command is transmitted from a remote commander.

3. The method according to claim 1, wherein the video file comprises an MPEG video file containing video complying with an MPEG video standard.

4. The method according to claim 1, wherein the listing is presented to the user in the form of a grid showing television programming as a function of time.

5. The method according to claim 1, carried out in a television Set-Top Box, and wherein the video file is stored in a local disc drive accessible by the Set-Top Box.

6. The method according to claim 1, wherein the video file is stored at content provider site.

7. The method according to claim 6, carried out in a television Set-Top Box, and wherein the video file is sent to the Set-Top Box as a streaming video file in response to the command.

8. The method according to claim 1, wherein when the video file is played, the video is displayed in a window of the electronic program guide.

9. The method according to claim 8, wherein the window comprises an active video window displayed by a browser.

10. The method according to claim 1, wherein the playing comprises playing the video file to provide a preview of the specified program to the user only if at least a portion of the specified program is scheduled for airing at a time in the future.

11. The method according to claim 1, wherein the playing further comprises playing an advertisement.

12. A television apparatus, comprising:
a programmed processor having access to a plurality of video files;
means for presenting an electronic program guide to a display for display to a user;
a receiver that receives a command from the viewer for initiating a preview of a specified program; and
a computer program running on the programmed processor that maps the command to one of the plurality of files stored on the video device and plays the video file to the display to provide a preview of the specified program to the user.

13. The apparatus according to claim 12, wherein the command is received from a remote commander.

14. The apparatus according to claim 12, wherein the video file comprises an MPEG video file containing video complying with an MPEG video standard.

15. The apparatus according to claim 12, wherein the electronic program guide is presented to the user in the form of a grid showing television programming as a function of time.

16. The apparatus according to claim 12, wherein the video file is stored in a local disc drive accessible by a television Set-Top Box.

17. The apparatus according to claim 12, wherein the video file is stored at content provider site.

18. The apparatus according to claim 17, wherein the video file is sent to the Set-Top Box as a streaming video file in response to the command.

19. The apparatus according to claim 12, wherein when the video file is played, the video is displayed in a window of the electronic program guide.

20. The apparatus according to claim 19, wherein the window comprises an active video window displayed by a browser.

21. The apparatus according to claim 12, wherein the playing comprises playing the video file to provide a preview of the specified program to the user only if at least a portion of the specified program is scheduled for airing at a time in the future.

22. The method according to claim 12, wherein the playing further comprises playing an advertisement.

23. A method of providing an electronic programming guide from a television Set-Top Box, comprising:
presenting a listing of television programs to a viewer in the form of a grid showing television programming as a function of time;
receiving a command transmitted by the viewer from a remote commander for initiating a preview of a specified program;
mapping the specified program to a video file containing a preview of the specified program, the video file comprising an MPEG video file containing video complying with an MPEG video standard;
wherein the video file is stored in a local disc drive accessible by the Set-Top Box;
determining if at least a portion of the specified program is scheduled for airing at a time in the future;
if so, playing the video file in a window of the electronic program guide to provide a preview of the specified program to the user by displaying the video in an active video window displayed by a browser running on the programmed processor; and
if not, displaying an error message.

24. An electronic storage medium storing instructions which, when executed on a programmed processor, carry out a method of providing an electronic programming guide, comprising:
presenting a listing of television programs to a viewer;
receiving a command from the viewer for initiating a preview of a specified program;
mapping the specified program to a video file containing a preview of the specified program; and
playing the video file to provide a preview of the specified program to the user.

25. A method of providing program previews to a viewer, comprising:
receiving a program preview file from a server;
storing the program preview file in a storage device;
receiving a program guide from the server;
determining from the program guide that the program preview file does not correspond to a program to be available at a future time; and
deleting the program preview file from the storage device.
